(19) United States
(12) Patent Application Publication
(10) Pub. No.: US 2009/0250347 A1
(43) Pub. Date: Oct. 8, 2009

(54) MICROFLUIDIC DEVICES & PROCESSES FOR ELECTROKINETIC TRANSPORT

(75) Inventors: Matthew Jacob Powell, Westover, WV (US); Trust Tariro Razunguzwa, Morgantown, WV (US); Jifeng Chen, Morgantown, WV (US)

Correspondence Address: K&L GATES LLP, 535 SMITHFIELD STREET, PITTSBURGH, PA, 15222, US

(73) Assignee: Protea Biosciences, Inc., Morgantown, WV (US)

(21) Appl. No.: 12/272,589

(22) Filed: Nov. 17, 2008

Related U.S. Application Data
(63) Continuation-in-part of application No. 12/061,865, filed on Apr. 3, 2008.

(51) Int. Cl. G01N 27/02; B01D 59/42

(52) U.S. Cl. 204/549; 204/645

(57) ABSTRACT

A microfluidic device for collecting a sample during electrokinetic transport may generally comprise a first channel intersecting a second channel to form a junction; a receptacle in fluid communication with the first channel to receive therein a sample comprising at least one analyte; a pair of electrodes associated with the first channel to create an electrophoretic field effective to electrokinetically transport the at least one analyte, wherein the second channel is substantially field-free of the electrophoretic field; and a first reservoir and a second reservoir in fluid communication with the first channel to create a pressure gradient between the channels effective to transport the at least one analyte from the first channel to the second channel when fluid is present in at least one of the reservoirs and the voltage is substantially simultaneously applied along the first channel.

### CROSS REFERENCE TO RELATED APPLICATION

This application is a continuation-in-part of U.S. application Ser. No. 12/061,865, filed on Apr. 3, 2008, which is hereby incorporated by reference in its entirety.

### BACKGROUND

This invention is generally related to devices and processes for electrokinetic transport of electrically charged particles, and in particular, microfluidic devices and processes for sample collection decoupled from the electric field.

The movement of electrically charged particles under the influence of an applied electric field is known as electrokinetic transport. Electrophoresis and capillary electrophoresis (CE) are well-known techniques used in biochemistry, genetics, molecular biology and other industries that utilize electrokinetic transport to separate, isolate, analyze and identify amino acids, peptides, proteins, nucleic acids, and other biomolecules. Examples of microfluidic CE devices and process are described in U.S. application Ser. No. 12/061,865, filed on Apr. 3, 2008, which is hereby incorporated by reference in its entirety.

In a CE system, a sample containing at least one charged analyte is introduced into a small capillary or channel filled with a conductive medium, e.g., a buffer solution. The charged analytes move through the interior of the capillary or channel under the influence of an electric field. The migration rate of the analytes through the conductive medium can depend on the amplitude of the applied electric field, the analytes' electrophoretic mobilities, and electroosmotic flow of the buffer solution. The analytes can be separated based on their different migration rates in the applied electric field. The separated analytes transiting the capillary can be detected with UV-Vis absorbance or fluorescence detectors positioned along the capillary.

Conventional CE sample collection techniques typically involve collecting the separated analytes in a collection vial as they elute from the capillary exit. The time required for each analyte to traverse the distance between the detection point and the capillary exit may be calculated if its migration rate and the distance between the detection point and the capillary exit are known. After the calculated time expires, the electrophoretic field can be turned off and the capillary can be removed from the CE system and placed into a collection vial containing a collection buffer solution and an electrode. To collect the separated analyte, current can be applied to the electrode in the collection vial for a predetermined period of time until the analyte migrates from the capillary exit into the collection vial. After collection, the capillary can be returned to the CE system and the analysis of the other analytes can continue.

Conventional CE sample collection techniques may suffer from low efficiency, limited capacity, reduced resolution, and/or the inherent difficulties of collecting a sample in an electric field. The throughput of the CE system can be limited if the electrophoretic field used to separate the analytes is turned off during sample collection. The additional volume of the collection buffer solution in the collection vial may dilute the separated analytes. The use of an electrode in the collection vial may lead to reduction-oxidation reactions of the collected analytes and a risk of electric shock to the user. In addition, the precise time that an analyte may elute from the capillary exit may be difficult to determine, particularly if analytes have similar migration rates. Other conventional CE sample collection techniques, such as collecting the separated analytes on a membrane, may collect the analytes in a form that cannot be used for further analysis without additional processing.

Accordingly, devices and processes that efficiently collect analytes during electrokinetic transport are necessary.

### SUMMARY

Although there have been several developments in microfluidic devices for electrokinetic transport, it would be an improvement to provide microfluidic devices and processes that may reproducibly and efficiently collect samples using a substantially simultaneous application of electrokinetic and hydrodynamic and/or hydrostatic forces.

Another improvement would be to provide microfluidic devices and processes that may electrophoretically separate a sample in a first channel while substantially simultaneously collecting another sample in a field-free channel that is decoupled from the electrophoretic field.

Another improvement would be to provide microfluidic devices and processes that may have higher loadability to separate and collect samples in parallel, and thereby improve throughput.

Another improvement would be to provide microfluidic devices and processes that may reduce sample degradation and analysis time during sample collection.

Another improvement would be to provide microfluidic devices and processes that may preserve the spatial resolution of the separation process in the collected sample.

Another improvement would be to provide microfluidic devices and processes that may collect a sample in a form that is compatible with other analysis techniques.

Another improvement would be to provide microfluidic devices and processes that may have multi-functional capability for separating and collecting a plurality of samples.

Another improvement would be to provide microfluidic devices and processes that may be used with automated systems, thereby providing the additional benefits of further cost reductions and decreased operator errors because of the reduction in human involvement.

Another improvement would be to provide microfluidic devices and processes that reduce the risk of electric shock to the user during sample collection.

In certain exemplary, non-limiting embodiments, more efficient and/or cost-effective microfluidic devices and processes for electrokinetic transport of electrically charged particles in which the sample collection is decoupled from the electrophoretic field are disclosed. In specific embodiments, the microfluidic devices and processes may be suitable for separating, isolating, analyzing, collecting, and/or identifying charged particles, such as, for example, but not limited to amino acids, peptides, proteins, nucleic acids, and other biomolecules.

In certain exemplary, non-limiting embodiments, a microfluidic device for sample collection during electrokinetic transport may generally comprise a first channel intersecting a second channel to form a junction; a receptacle in fluid communication with the first channel to receive therein a sample comprising at least one analyte; a pair of electrodes associated with the first channel to create an electrophoretic field along the first channel effective to electrokinetically transport the at least one analyte when a conductive medium and the electrodes are present in the first channel and a voltage is applied to the electrodes, wherein the second channel is substantially field-free of the electrophoretic field; and a first reservoir and a second reservoir in fluid communication with the first channel to create a pressure gradient between the first and second channels effective to transport the at least one analyte from the first channel into the second channel when fluid is present in at least one of the reservoirs and the electrophoretic field is substantially simultaneously applied along the first channel. In at least one embodiment, the pressure gradient may be hydrostatic pressure proportional to the height of fluid in the first and/or second reservoirs. In at least one embodiment, the pressure gradient may be a pressure drop between the first and second channels effective to transport the at least one analyte from the junction into the second channel. In at least one embodiment, the device may further comprise a third reservoir in fluid communication with the second channel wherein the first and second reservoirs have a combined volume of fluid greater than a volume of fluid of the third reservoir to create the pressure drop.

In certain exemplary, non-limiting embodiments, a method of sample collection during electrokinetic transport may generally comprise the steps of providing a microfluidic device for electrokinetic transport of at least one analyte having a first channel intersecting a second channel to form a junction; introducing a sample comprising the at least one analyte to the first channel; applying an electrophoretic field along the first channel effective to transport the at least one analyte into the junction, wherein the second channel is substantially field-free from the electrophoretic field; substantially simultaneously applying a pressure gradient across the junction to move the at least one analyte from the junction into the second channel; and collecting the analyte in the second channel. In at least one embodiment, the method of sample collection during electrokinetic transport may further comprise the step of introducing a volume of fluid to at least one of first and second reservoirs in fluid communication with the first channel to create the pressure drop from the first channel into the second channel. In at least one embodiment, the pressure gradient may be created by hydrostatic pressure proportional to the height of fluid in the first and/or second reservoirs. In at least one embodiment, the at least one analyte at the junction may have a pressure-driven velocity greater than an electrophoretic velocity to move the analyte into the second channel.

### BRIEF DESCRIPTION OF THE DRAWING FIGURES

The various exemplary, non-limiting embodiments of microfluidic devices and processes described herein may be better understood by considering the following description in conjunction with one or more of the accompanying drawing figures in which like reference numbers refer to like elements.

FIG. 1 illustrates a schematic top view of an embodiment of a microfluidic device.

FIG. 2 illustrates a schematic view of an embodiment of a microfluidic device.

FIG. 3 illustrates a schematic view of an embodiment of a microfluidic device.

FIG. 4A illustrates a schematic view of an embodiment of a microfluidic device.

FIG. 4B illustrates a schematic view of an embodiment of a microfluidic device.

FIG. 5 illustrates a perspective view of an embodiment of a microfluidic device.

FIG. 6A illustrates a front view of an embodiment of a microfluidic device.

FIG. 6B illustrates a partial rear view of an embodiment of a microfluidic device.

FIG. 7A illustrates a front view of an embodiment of a microfluidic device.

FIG. 7B illustrates a partial rear view of an embodiment of a microfluidic device.

FIG. 8 illustrates a schematic view of an embodiment of a microfluidic device illustrating the movement of an analyte upon the simultaneous application of an electrophoretic field and pressure gradient.

### DESCRIPTION OF CERTAIN EMBODIMENTS

### A. Definitions

As used herein, the term “comprising” means various components conjointly employed in the preparation of the devices and processes disclosed herein. Accordingly, the terms “consisting essentially of” and “consisting of” are embodied in the term “comprising”.

As used herein, the articles including “the”, “a” and “an” when used in a claim or in the specification, are understood to mean one or more of what is claimed or described.

As used herein, the terms “include”, “includes” and “including” are meant to be non-limiting.

As used herein, the term “plurality” means more than one.

As used herein, the term “capillary electrophoresis” means capillary zone electrophoresis, capillary gel electrophoresis, capillary isoelectric focusing, capillary isotachophoresis, and micellar electrokinetic chromatography.

As used herein, the term “conductive medium” means any fluid, solid, liquid, or gel capable of moving an electric charge, such as, for example, but not limited to, buffer solutions, running buffer solutions, elution liquids, acrylamide gels, e.g., polyacrylamide and/or agarose matrices, and the like.

As used herein, the term “microfluidic” means structures or devices through which a fluid is capable of being passed or directed, wherein one or more of the dimensions is less than about 500 microns, e.g., depth, width, length, diameter, etc. In the devices of the present invention, the microstructures may have at least one cross-sectional dimension between about 0.1 microns and 250 microns, and often between about 0.1 microns and 100 microns.

As used herein, the term “microstructure” means microfluidic structures, e.g., “microchannels” and “microchambers” or any combination thereof. A microchannel has a dimensional feature that is at least about 1 micron but less than about 500 microns in size. During operation, microchannels and microchambers may contain fluids passing therein and/or therethrough. The term “channel” as used herein describes a microchannel.

As used herein, the terms “microfluidic chip” and “microfluidic device” means at least one substrate having microfluidic structures contained therein or thereon.

Any numerical range recited herein is intended to include all sub-ranges subsumed therein. For example, a range of “1 to 10” is intended to include all sub-ranges between and including the recited minimum value of 1 and the recited maximum value of 10, that is, having a minimum value equal to or greater than 1 and a maximum value of equal to or less than 10.

This disclosure describes several various features and aspects of microfluidic devices and processes with reference to various exemplary, non-limiting embodiments. It is understood, however, that the microfluidic devices and processes described herein embrace numerous alternative embodiments, which may be accomplished by combining any of the different features, aspects, and embodiments described herein in any combination that one of ordinary skill in the art may find useful. In specific embodiments, microfluidic devices and methods for electrokinetic transport and capillary electrophoresis of a microscale sample are disclosed. The microfluidic devices and processes disclosed herein may be suitable for scale-up to conventional CE systems without undue experimentation.

### A. Fabrication of Microfluidic Devices

In certain exemplary, non-limiting embodiments, the microfluidic devices may be typically constructed using one or more substrates. Substrates may be typically made from a transparent material to aid observation; however, non-transparent materials may be used. Suitable transparent substrate materials may include, for example, but not limited to, glass, polymeric, ceramic, metallic, silica-based, and composite materials, as well as any combination thereof. Examples of polymeric materials typically used may include polystyrene, polypropylene, polyethylene, acrylonitrile butadiene styrene, polycarbonate, polymethyl methacrylate, cyclic olefin copolymer, polyester, polyimide, polyamide, or other acrylics, or any combination thereof. In the case of electrically conductive, semi-conductive, or surface charge bearing substrates, a chemical treatment may be applied to provide the substrate a near-neutral or neutral surface charge to eliminate or reduce bulk electroosmotic flow within the microstructures. In at least one embodiment, the microfluidic device may comprise an electrically non-conductive substrate. In at least one embodiment, the microfluidic device may comprise a conductive substrate in which the channels and/or microstructures have a substantially surface charge-neutralizing coating. In at least one embodiment, the microfluidic device may comprise a surface charge bearing substrate in which the channels and/or microstructures have a substantially surface charge-neutralizing coating.

In certain exemplary, non-limiting embodiments, the microfluidic devices may comprise a plurality of microstructures, e.g., microchannels and microchambers, to transport fluids into, out of, and onto the various structures within the microfluidic devices, or any combination thereof. The microstructures may be prepared on substrates using standard manufacturing techniques. For example, lithographic techniques may be employed in fabricating glass, quartz or silicon substrates. In addition, photolithographic masking, plasma or wet etching, and other semiconductor processing technologies may be used. Alternatively, micromachining methods, such as laser ablation, micromilling, and the like may be employed. Similarly, well known manufacturing techniques may also be used for polymeric substrates, e.g., compression molding, stamp molding, and injection molding, casting or embossing, and the like. For example, microchannels may be prepared by compression molding and microchambers may be prepared by using a diamond tipped drill, such as a microdrill. In order to provide fluid and/or control access to the microstructures, a series of reservoirs or ports in fluid communication with the microstructures may be provided in at least one of the substrates.

In certain exemplary, non-limiting embodiments, the microfluidic devices may include at least two substrates, e.g., a cover substrate and a base substrate, which may be bonded together. The cover substrate and the base substrate may be bonded together by adhesive bonding, cohesive bonding, thermal bonding, mechanical bonding or any combination thereof. The bonding of the substrates may provide regions for containing microstructures, e.g., a plurality of microchannels and microchambers, in both the base and/or over substrates. When bonded together, the spatial arrangement of the microfluidic structures in the cover substrate may be designed to be in fluid communication with the regions containing the microfluidic structures in the base substrate.

### B. Microfluidic Device

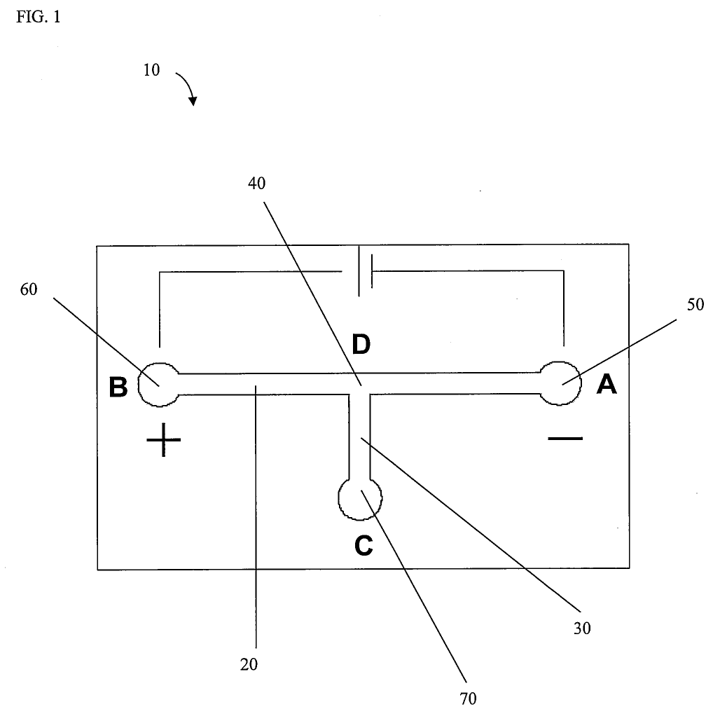

Referring to FIG. 1, certain exemplary, non-limiting embodiments of a microfluidic device for sample collection during electrokinetic transport 10 may generally comprise a first channel 20 intersecting a second channel 30 to form a junction 40; a receptacle in fluid communication with the first channel 20 to receive therein a sample comprising at least one analyte; a pair of electrodes (not shown) associated with the first channel 20 to create an electrophoretic field along the first channel 20 effective to electrokinetically transport the at least one analyte when a conductive medium and the electrodes are present in the first channel 20 and a voltage is applied to the electrodes, wherein the second channel 30 is substantially field-free of the electrophoretic field; and a first reservoir 50 and a second reservoir 60 in fluid communication with the first channel 20 to create a pressure gradient between the first 20 and second 30 channels effective to transport the at least one analyte from the first channel 20 into the second channel 30 when fluid is present in at least one of the reservoirs 50, 60 and the electrophoretic field is substantially simultaneously applied along the first channel 20. In at least one embodiment, the second channel 30 may be substantially field-free of the electrophoretic field. In at least one embodiment, at least one of the first 50 and second 60 reservoirs may comprise the receptacle. In at least one embodiment, the device may further comprise a third reservoir 70 in fluid communication with the second channel 30.

In certain exemplary, non-limiting embodiments, the microfluidic device 10 may comprise a substrate having series of channels 20, 30 intersecting at any angle to form the junction 40. In at least one embodiment, the angle between the first 20 and second 30 channels may be between 0 degrees and about 90 degrees. In at least one embodiment, the angle between the first 20 and second 30 channels may be between about 15 degrees and about 75 degrees. In at least one embodiment, the angle between the first 20 and second 30 channels may be between about 35 degrees and about 55 degrees. In at least one embodiment, the angle between the first 20 and second 30 channels may be about 45 degrees. In at least one embodiment, the angle between the first 20 and second 30 channels may be about 90 degrees. In certain embodiments, the angle between the first 20 and second 30 channels may contribute to the pressure gradient between the first 20 and second 30 channels.

In certain exemplary, non-limiting embodiments, each channel 20, 30 may be independently selected from any shape, e.g., rectangular, circular, and trapezoidal. In at least one embodiment, the channels 20, 30 may be rectangular. In at least one embodiment, the channels 20, 30 may be trapezoidal. In at least one embodiment, the channels 20, 30 may be between about 0.1 μm and about 1000 μm in width and depth. In at least one embodiment, the channels 20, 30 may be between about 1 μm and about 500 μm in width and depth. In at least one embodiment, the channels 20, 30 may be between about 100 μm and about 500 μm in width and depth. In at least one embodiment, the width and depth of each of the channels 20, 30 may be about 200 μm. In at least one embodiment, the channels 20, 30 may be circular. In at least one embodiment, the diameter of the channels 20, 30 may be between about 1 μm and about 500 μm. In at least one embodiment, the diameter of the channels 20, 30 may be about 200 μm. In certain embodiments, the shape, diameter, and/or cross-sectional dimensions of the channels 20, may be independently configured to contribute to the pressure gradient between the first 20 and second 30 channels.

In certain exemplary, non-limiting embodiments, the length of the channels 20, 30 may be independently configured to contribute to the pressure gradient between the first 20 and second 30 channels. In at least one embodiment, the lengths of the channels 20, 30 may be between about 1 mm and about 100 mm. In at least one embodiment, the lengths of the channels 20, 30 may be between about 5 mm and about 50 mm. In at least one embodiment, the lengths of the channels 20, 30 may be between about 20 mm and about 30 mm. As shown in FIG. 1, the length of the first channel 20 may be greater than the length of the second channel 30. In at least one embodiment, the first channel 20 may be greater than ten times longer than the second channel 30. In at least one embodiment, the first channel 20 may be greater than one hundred times longer than the second channel 30. In at least one embodiment, the length of the first channel 20 may be about 20 mm and the length of the second channel 30 may be about 15 mm. In at least one embodiment, the lengths of the first 20 and second 30 channels may be about equal. In at least one embodiment, the length of the first channel may be about 20 mm and the length of the second channel may be about 20 mm. In at least one embodiment, the length of the first channel may be shorter than the length of the second channel. In at least one embodiment, the second channel 30 may be greater than ten times longer than the first channel 20. In at least one embodiment, the second channel 30 may be greater than one hundred times longer than the first channel 20. In at least one embodiment, the length of the first channel 20 may be about 20 mm and the length of the second channel 30 may be about 26 mm.

As shown in FIG. 1, certain exemplary, non-limiting embodiments of the microfluidic device 10 may comprise at least one of a first reservoir 50 and a second reservoir 60 in fluid communication with the first channel 20, and a third reservoir 70 in fluid communication with the second channel 30. In at least one embodiment, the first reservoir 50 may be positioned along a first portion of the first channel 20. In at least one embodiment, the second reservoir 60 may be positioned along a second portion of the first channel 20. In at least one embodiment, the first reservoir 50 may be positioned along a first end of the first channel 20 and the second reservoir 60 may be positioned along an opposing end of the first channel 20. In at least one embodiment, the first reservoir 50 may be positioned intermediate an inlet in fluid communication with the first channel 20 and the junction 40. In at least one embodiment, the first reservoir 50 may comprise the inlet in fluid communication with the first channel 20. In at least one embodiment, the second reservoir 60 may be positioned intermediate the junction 40 and an outlet in fluid communication with the first channel 20. In at least one embodiment, the second reservoir 60 may comprise the outlet in fluid communication with the first channel 20. In at least one embodiment, the junction 40 may be positioned intermediate the first 50 and second 60 reservoirs. In at least one embodiment, the third reservoir 70 may be positioned along the second channel 30 opposing the junction 40. In at least one embodiment, the third reservoir 70 may be positioned intermediate the junction 40 and an outlet in fluid communication with the second channel 30. In at least one embodiment, the third reservoir 70 may comprise the outlet in fluid communication with the second channel 30.

In certain exemplary, non-limiting embodiments, the microfluidic device 10 may comprise a receptacle in fluid communication with the first channel 20 to receive therein a sample containing at least one analyte. In at least one embodiment, the at least one analyte may comprise charged particles. In at least one embodiment, the at least one analyte may be selected from the group consisting of anionic species and cationic species. In at least one embodiment, the at least one analyte may be at least one biopolymer. In at least one embodiment, the at least one analyte may be selected from the group consisting of amino acids, peptides, proteins, nucleic acids, and the like. In at least one embodiment, the receptacle may be positioned intermediate the pair of electrodes (not shown). In at least one embodiment, the receptacle may be positioned intermediate the first 50 and second 60 reservoirs. In at least one embodiment, the first reservoir 50 may comprise the receptacle. In at least one embodiment, the second reservoir 60 may comprise the receptacle.

In certain exemplary, non-limiting embodiments, the height, diameter, volume and/or cross-sectional dimensions of the reservoirs 50, 60, 70 may be independently configured to create a pressure gradient between the first 20 and second 30 channels when fluid is present in at least one of the reservoirs 50, 60, 70. In at least one embodiment, the pressure gradient may be a pressure drop from the first channel 20 to the second channel 30. In at least one embodiment, the pressure gradient may be a pressure drop from the junction 40 to the second channel 30. In at least one embodiment, the pressure gradient may encourage electrokinetically transported analytes to move from the first channel 20 into the second channel 30. In at least one embodiment, the pressure drop may transfer at least one analyte in the junction 40 to the second channel 30. In at least one embodiment, the pressure gradient may be hydrostatic pressure proportional to the height of fluid present in the first 50 and/or second 60 reservoirs. In at least one embodiment, the pressure gradient may be a pressure drop from the first channel 20 to the second channel 30 proportional to the height of fluid present in the first 50 and/or second 60 reservoirs. In at least one embodiment, the pressure gradient may be a pressure drop from the junction 40 to the second channel 30 proportional to the height of fluid present in the first 50 and/or second 60 reservoirs.

In certain exemplary, non-limiting embodiments, the height of the reservoirs 50, 60, 70 may be independently configured to create a pressure gradient between the first 20 and second 30 channels when fluid is present in at least one of the reservoirs 50, 60, 70. In at least one embodiment, the height of at least one of the reservoirs 50, 60, 70 may be between about 0.5 cm and about 10 cm. In at least one embodiment, the height of at least one of the reservoirs 50, 60, 70 may be about 1 cm. In at least one embodiment, the height of fluid present in the first 50 and/or second 60 reservoirs may be greater than the height of fluid present in the third reservoir 70. In at least one embodiment, the height of fluid present in the first 50 and/or second 60 reservoirs may be greater than two times the height of fluid present in the third reservoir 70. In at least one embodiment, the height of fluid present in the first 50 and/or second 60 reservoirs may be greater than five times the height of fluid present in the third reservoir 70. In at least one embodiment, the height of fluid present in the first 50 and/or second 60 reservoirs may be greater than ten times the height of fluid present in the third reservoir 70. In at least one embodiment, the height of fluid present in the first 50 and/or second 60 reservoirs may be between about 1 mm and about 25 mm. In at least one embodiment, the height of fluid present in the first 50 and/or second 60 reservoirs may be between about 5 mm and about 15 mm. In at least one embodiment, the height of fluid present in the first 50 and/or second 60 reservoirs may be between about 8 mm and about 12 mm. In at least one embodiment, the height of fluid present in the third reservoir 70 may be between about 0 mm and about 20 mm. In at least one embodiment, the height of fluid present in the third reservoir 70 may be between about 0 mm and about 10 mm. In at least one embodiment, the height of fluid present in the third reservoir 70 may be between about 0 mm and about 5 mm.

In certain exemplary, non-limiting embodiments, the diameter of the reservoirs 50, 60, 70 may be independently configured to create a pressure gradient between the first 20 and second 30 channels when fluid is present in at least one of the reservoirs 50, 60, 70. In at least one embodiment, the diameter of the first 50 and/or second 60 reservoirs may be greater than two times the diameter of the third reservoir 70. In at least one embodiment, the diameter of the first 50 and/or second 60 reservoirs may be greater than five times the diameter of the third reservoir 70. In at least one embodiment, the diameter of the first 50 and/or second 60 reservoirs may be greater than ten times the diameter of the third reservoir 70. In at least one embodiment, the diameter of at least one of the reservoirs 50, 60, 70 may be between about 0.5 mm to about 10 mm. In at least one embodiment, the diameter of at least one of the reservoirs 50, 60, 70 may be between about 2 mm to about 8 mm. In at least one embodiment, the diameter of at least one of the reservoirs 50, 60, 70 may be between about 4 mm to about 6 mm. In at least one embodiment, the diameter of at least one of the reservoirs 50, 60, 70 may be about 5 mm.

In certain exemplary, non-limiting embodiments, the volume and/or cross-sectional dimensions of the reservoirs 50, 60, 70 may be independently configured to create a pressure gradient between the first 20 and second 30 channels when fluid is present in at least one of the reservoirs 50, 60, 70. In at least one embodiment, the combined volume of the first 50 and/or second 60 reservoirs is greater than a volume of the third reservoir 70. In at least one embodiment, the combined volume of fluid present in the first 50 and/or second 60 reservoirs is greater than a volume of fluid present, if any, in the third reservoir 70. In at least one embodiment, the combined volume of fluid present in the first 50 and/or second 60 reservoirs may be greater than two times the volume of fluid present in the third reservoir 70. In at least one embodiment, the combined volume of fluid present in the first 50 and/or second 60 reservoirs may be greater than five times the volume of fluid present in the third reservoir 70. In at least one embodiment, the combined volume of fluid present in the first 50 and/or second 60 reservoirs may be greater than ten times the volume of fluid present in the third reservoir 70. In at least one embodiment, the combined volume of fluid present in the first 50 and/or second 60 reservoirs may be about 10 μL to about 1000 μL. In at least one embodiment, the combined volume of fluid present in the first 50 and/or second 60 reservoirs may be about 100 μL to about 600 μL. In at least one embodiment, the combined volume of fluid present in the first 50 and/or second 60 reservoirs may be about 400 μL and the third reservoir 70 may be substantially empty.

In at least one embodiment, the volume of fluid present in each of the first 50 and/or second 60 reservoirs may be between about 0 μL and about 1000 μL. In at least one embodiment, the volume of fluid present in each of the first 50 and/or second 60 reservoirs may be between about 10 μL and about 500 μL. In at least one embodiment, the volume of fluid present in each of the first 50 and/or second 60 reservoirs may be between about 50 μL and about 200 μL. In at least one embodiment, the volume of fluid present in each of the first 50 and/or second 60 reservoirs may be about 200 μL. In at least one embodiment, the volume of fluid present in the third reservoir 70 may be between about 0 μL and about 500 μL. In at least one embodiment, the volume of fluid present in the third reservoir 70 may be between about 0 μL and about 200 μL. In at least one embodiment, the volume of fluid present in the third reservoir 70 may be between about 0 μL and about 50 μL.

In certain exemplary, non-limiting embodiments, the engineering of the channels, reservoirs, and microstructures may be optimized to create a pressure gradient between the first 20 and second 30 channels. In at least one embodiment, the magnitude of the pressure drop may be increased by increasing the length of the first channel 20 and/or decreasing the length of the second channel 30. In at least one embodiment, the magnitude of the pressure drop may be increased by decreasing the radius or cross-sectional dimensions of the first channel 20 and/or increasing the radius or cross-sectional dimensions of the second channel 30. In at least one embodiment, the magnitude of the pressure drop may be increased by providing a microchamber (not shown) along the second channel 30 intermediate the junction 40 and the outlet along the second channel 30. In at least one embodiment, the magnitude of the pressure drop may be increased by increasing the radius and/or cross-sectional dimensions of the microchamber (not shown). In at least one embodiment, the magnitude of the pressure drop may be increased by increasing the volume of fluid in the first 50 and/or second 60 reservoirs and/or decreasing the volume of fluid in the third reservoir 70. Although the engineering of the channels and other microstructures may be optimized to increase the magnitude of the pressure drop from the first channel 20 to the second channel 30, the pressure drop may be greatly diminished without the presence of at least one of the reservoirs 50, 60, 70. The engineering of the channels, reservoirs, and microstructures should limit the magnitude of the pressure drop to prevent overflowing the second channel 20 and/or third reservoir 70.

In certain exemplary, non-limiting embodiments, the microfluidic device may further comprise at least one of flow restricting features (not shown) that discourage the migration of the sample towards the second reservoir 60 and flow enhancing features (not shown) that encourage the migration of the sample towards the second channel 30. In at least one embodiment, at least one of the flow restricting features may be positioned intermediate the junction 40 and the outlet in fluid communication with the first channel 20 to discourage flow into the outlet in fluid communication with the first channel 20 and/or encourage flow into the second channel 30. In at least one embodiment, at least one of the flow enhancing features may be positioned intermediate the junction 40 and the outlet in fluid communication with the second channel 30 to encourage flow into the second channel 30. In at least one embodiment, the flow enhancing features may comprise a microchamber (not shown) having a larger diameter than the first channel 20 to encourage fluid flow towards the second channel 30. In at least one embodiment, the flow restricting features may comprise a flow restrictor (not shown) to discourage fluid flow towards the second reservoir 60. In at least one embodiment, the flow restricting and flow enhancing features may be fluid flow, osmotic, gravitational, hydrodynamic, pressure gradient, capillary action, or mechanical structures, such as nanoporous or microporous frits.

In certain exemplary, non-limiting embodiments, the microfluidic device 10 may further comprise a sorbent material (not shown) that may collect and/or concentrate the separated analytes. In at least one embodiment, the chromatographic and/or extraction systems may be a sorbent material selected from the group consisting of partition chromatography, adsorption chromatography, ion exchange and ion chromatography, size exclusion chromatography, affinity chromatography, chiral chromatography, and the like. In at least one embodiment, the microfluidic device 10 may further comprise a sorbent material in the second channel 30 such that the sorbent material is substantially decoupled from the electrophoretic field. In at least one embodiment, the sorbent material may be substantially field-free from the electrophoretic field along the first channel 20. The collection of the separated analytes may be improved by decoupling the sorbent material from the electrophoretic field.

In certain exemplary, non-limiting embodiments, the sorbent material may comprise a monolith, a packed bed, or other suitable materials that may act as chromatographic and/or extraction systems. In at least one embodiment, the monolith may comprise a porous polymer monolith or a functionalized porous polymer monolith formed integrally in the second channel 30. In at least one embodiment, the monolith may comprise a porous silica monolith or a functionalized porous silica monolith formed integrally in the second channel 30. In at least one embodiment, the monolith may comprise a porous hybrid polymeric-silica monolith or a functionalized hybrid polymeric-silica monolith formed integrally in the second channel 30. Examples of preparing porous polymer monoliths, functionalized porous polymer monolith, porous silica monoliths, functionalized porous silica monoliths, porous hybrid polymeric-silica monoliths and functionalized hybrid polymeric-silica monoliths are described in Frantisek Svec et al., eds., Monolithic materials: preparation, properties, and applications, (Elsevier, 2003), Journal of Chromatography Library, 67, the disclosure of which is hereby incorporated by reference in its entirety.

A porous polymer monolith generally refers to highly cross-linked porous polymer materials that permit fluid communication through the pores. A porous polymer monolith may be functionalized to have chemical moieties on the surfaces of its pores that may be capable of interacting with and/or bonding to macromolecules or other analytes contacting or passing through its pores. A functionalized porous polymer monolith may be prepared by including a polymerizable functionalized monomer in a reaction mixture for preparing the porous polymer monolith or post-functionalizing the porous polymer monolith after it is formed. The functionalized monomer may be selected to contain a functional group that directly binds or interacts to a particular analyte or probe compound capable of selectively binding to or interacting with the particular analyte. For example, the functionalized porous polymer monolith may have reversed phase (e.g., C₄, C₈, or C₁₈) or ion exchange chemistry. In at least one embodiment, the functionalized porous monolith may have bioactive molecules (e.g. enzymes) conjugated or immobilized to the surface.

In certain exemplary, non-limiting embodiments, the porous polymer monolith may be formed integrally in the channel by photoinitiated or thermally initiated in situ polymerization. A method of making a porous polymer monolith within a channel of a microfluidic module may generally comprise copolymerization of a monomer, a crosslinking agent, one or more porogenic solvents and an initiator inside a microchannel. For example, a polymerization mixture containing 18% (Wt) butyl, octyl or lauryl acrylate, 12% (Wt) ethylene glycol dimethacrylate (EDMA), 69.5% (Wt) methanol and 2-propanol (porogens), and 0.5% (Wt) benzoin methyl ether (photoinitiator) can be added to the microchannel and exposed to an 8 W ultraviolet-light at 365 nm to form a hydrophobic polymer monolith within the microchannel. The polymerization may be limited to only those portions of the channel that are exposed to ultraviolet-light, i.e., those portions of the channel that are not masked to prevent exposure of ultraviolet-light to the polymerization mixture. The functionalized porous polymer monolith may be bonded to the microstructure and/or substrate.

In certain exemplary, non-limiting embodiments, the microfluidic device 10 may further comprise a power supply (not shown) to apply a voltage to the electrodes (not shown) to create an electrophoretic field along the first channel 20 when a conductive medium is present in the first channel 20. In at least one embodiment, the microfluidic device 10 may further comprise a first electrode (not shown) associated with the first reservoir 50 and a second electrode (not shown) associated with the second reservoir 60 to create an electrophoretic field along the first channel 20 when a conductive medium is present in the first channel 20 and a voltage is applied to the electrodes (not shown). In at least one embodiment, the electrodes (not shown) may create an electrophoretic field across the first reservoir 50. In at least one embodiment, the electrodes (not shown) may create an electrophoretic field across the second reservoir 60. In at least one embodiment, the electrodes (not shown) may create an electrophoretic field across the receptacle.

In at least one embodiment, the second channel 30 may be field-free from the electrophoretic field along the first channel 20. In at least one embodiment, the electrophoretic field along the first channel 20 may leak into the second channel 30. In at least one embodiment, the electric field may induce electrokinetic transport of the at least one analyte in the direction from the first electrode (not shown) to the second electrode (not shown). In at least one embodiment, a sample containing the at least one analyte may be migrated or separated in the first channel 20 by electrokinetic transport. In at least one embodiment, the electrokinetic transport may be capillary electrophoresis. The electrodes may be any electrodes known in the art, such as, for example, but not limited to, a simple conductor connected to a source of electricity.

In certain exemplary, non-limiting embodiments, the microfluidic device 10 may further comprise a manifold (not shown) for sealing the reservoirs and associating the electrodes with the reservoirs. In at least one embodiment, the microfluidic device 10 may further comprise a manifold (not shown) having first and second electrodes, a first reservoir cover and a second reservoir cover for enclosing the first 50 and second 60 reservoirs, respectively, and associating the electrodes in fluid communication with the first channel 20 such that the electrodes are carried by the manifold. In at least one embodiment, the manifold (not shown) may further comprise a third reservoir cover for enclosing the third reservoir 70.

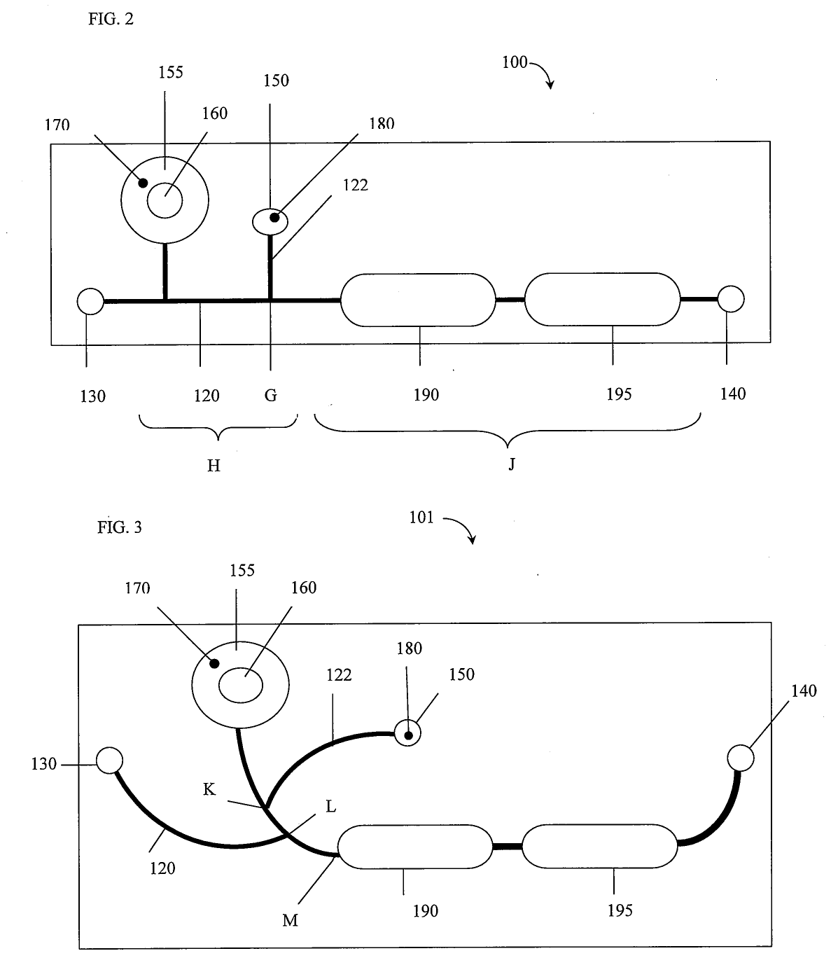

Referring to FIGS. 2 and 3, certain exemplary, non-limiting embodiments of microfluidic devices 100 and 101, respectively, for sample collection during electrokinetic transport may generally comprise a channel 120 having an inlet 130 and an outlet 140, a receptacle 160 in fluid communication with the channel 120 intermediate the inlet 130 and outlet 140, a first port 160 and a second port 150 in fluid communication with the channel 120, the second port 150 positioned intermediate the receptacle 160 and outlet 140, the receptacle 160 positioned between the first 160 and second 150 ports, the first 160 and second 150 ports adapted to receive a first electrode 170 and a second electrode 180, respectively, such that electrodes 170, 180 may complete an electrical circuit when fluid is present in the channel 120 to create the electrophoretic field across the receptacle 160 when a voltage is applied to electrodes 170, 180, and a flow restricting feature and/or a flow enhancing feature in fluid communication with the channel 120 intermediate the second port 150 and outlet 140 such that fluid flow in the channel 120 towards the outlet 140 is encouraged and fluid flow in the channel 120 towards the second port 150 is discouraged.

In certain exemplary, non-limiting embodiments, the flow restricting feature may be a branch channel 122 intermediate the second port 150 and the channel 120 such that the branch channel 122 may have a smaller diameter than the channel 120 to discourage fluid flow towards the second port 50. In at least one embodiment, the branch channel 122 may connect the second port 150 to the channel 120 at a junction G. In at least one embodiment, a flow restrictor (not shown) may be positioned in the branch channel 122 to further discourage flow thereinto. In at least one embodiment, the flow enhancing feature may be a microchamber 190 having a larger diameter than the channel 120 intermediate the branch channel 122 and the outlet 140 such that fluid flow towards the outlet 140 is encouraged.

In certain exemplary, non-limiting embodiments, microfluidic devices 100, 101, respectively, for sample collection during electrokinetic transport may generally further comprise a sorbent material 195 that may collect and/or concentrate the separated analytes in the channel 120 intermediate the second port 150 and the outlet 140 such that the sorbent material 195 is decoupled from the electrophoretic field created between the electrodes 170, 180. In at least one embodiment, the sorbent material 195 may be selected from the group consisting of a porous polymer monolith, a porous silica monolith, a porous hybrid polymer-silica monolith, a packed bed, and other suitable materials that may act as chromatographic and/or extraction systems. In at least one embodiment, the chromatographic and/or extraction systems provided by the sorbent material 195 may include partition chromatography, adsorption chromatography, ion exchange and ion chromatography, size exclusion chromatography, affinity chromatography, and chiral chromatography.

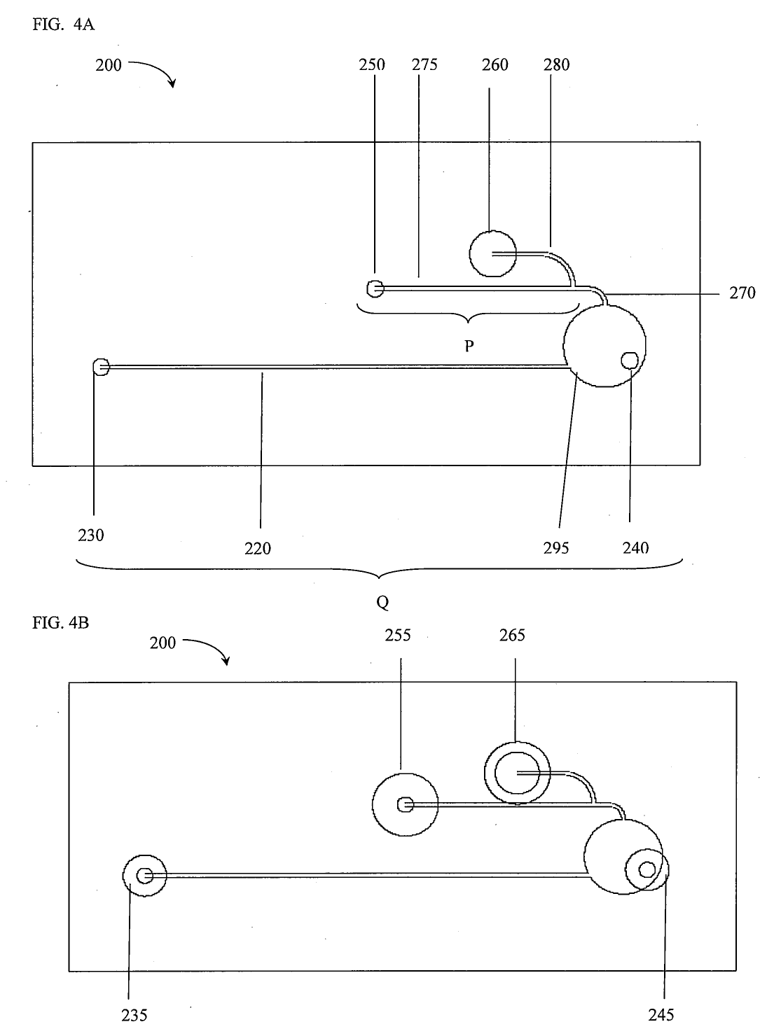

Referring to FIGS. 4A and 4B, certain exemplary, non-limiting embodiments of a microfluidic device 200 for sample collection during electrokinetic transport may generally comprise a channel 220 having a first fluid pathway P in fluid communication with a second fluid pathway Q, the first fluid pathway P comprising a first port 260 in fluid communication with a second port 250, and a receptacle (not shown) adapted to receive therein a sample (not shown) containing the at least one analyte, the receptacle in fluid communication with the first port 260, the second fluid pathway Q comprising an inlet 230 in fluid communication with an outlet 240, wherein the first port 260 is associated with a first electrode (not shown) and the second port 250 is associated with a second electrode (not shown) such that the electrodes may create an electrophoretic field across the receptacle when fluid is present in the channel 220 and a voltage is applied to the electrodes, wherein the channel 270 is configured to create a pressure drop from the first fluid pathway P to the second fluid pathway Q when fluid is present in the reservoirs 250, 260, and wherein the pressure drop encourages the separated analytes to move from the first fluid pathway P into the second fluid pathway Q. In at least one embodiment, the microfluidic device 200 may further comprise at least one of a first reservoir 265 in fluid communication with the first port 260, a second reservoir 255 in fluid communication with the second port 250, a third reservoir 245 in fluid communication with the outlet 240, and a fourth reservoir 235 in fluid communication with the inlet 230. In at least one embodiment, a pressure drop may be created from the first fluid pathway P to the second fluid pathway Q by using at least one of flow enhancing features and/or flow discouraging features. In at least one embodiment, the first reservoir 265 may further comprise the receptacle. In at least one embodiment, the channel 220 may be formed from a non-conductive substrate, or a conductive substrate or surface charge bearing substrate with a substantially surface charge-neutralizing coating. In at least one embodiment, the microfluidic device 200 may comprise a cover substrate (FIG. 4A) in fluid communication with a base substrate (FIG. 4B).

In certain exemplary, non-limiting embodiments, the second fluid pathway Q may further comprise at least one microchamber 295 intermediate the first fluid pathway P and the outlet 240, and a first channel segment 270 intermediate the first fluid pathway P and the microchamber 295. In at least one embodiment, the first fluid pathway P may further comprise a second channel segment 275 intermediate the second port 250 and the first channel segment 270, and a third channel segment 280 intermediate the first port 260 and the first channel segment 270.

In certain exemplary, non-limiting embodiments, the microfluidic device 200 may further comprise a sorbent material (not shown) in the second fluid pathway Q, e.g., a monolith or packed bed. In at least one embodiment, the monolith may be a porous polymer monolith formed integrally in the second fluid pathway Q, e.g., the monolith may be a porous polymer monolith formed integrally in the microchamber 295 in the second fluid pathway Q. In at least one embodiment, the monolith may be a porous silica or porous hybrid polymer-silica monolith formed integrally in the second fluid pathway Q, e.g., the monolith may be a porous silica or porous hybrid polymer-silica monolith formed integrally in the microchamber 295 in the second fluid pathway Q. The pressure drop from the first fluid pathway P to the second fluid pathway Q may be disrupted if the sorbent material fills a significant portion of the microchamber 295 and produces back pressure. In at least one embodiment, the sorbent material may fill between about 5% and about 90% of the microchamber 295. In at least one embodiment, the sorbent material may fill between about 10% and about 75% of the microchamber 295. In at least one embodiment, the sorbent material may fill between about 25% and about 50% of the microchamber 295.

### C. Microfluidic Chips

In certain exemplary, non-limiting embodiments, the microfluidic device may further comprise a microfluidic chip. In at least one embodiment, the microfluidic chip may be formed from a base substrate and a cover substrate having a series of microstructures in fluid communication therein and/or thereon. In at least one embodiment, the microfluidic chip may further comprise a plurality of modules each having the channels, receptacle, pair of electrodes, and reservoirs of the microfluidic devices described above to separately perform sample collection during electrokinetic transport.

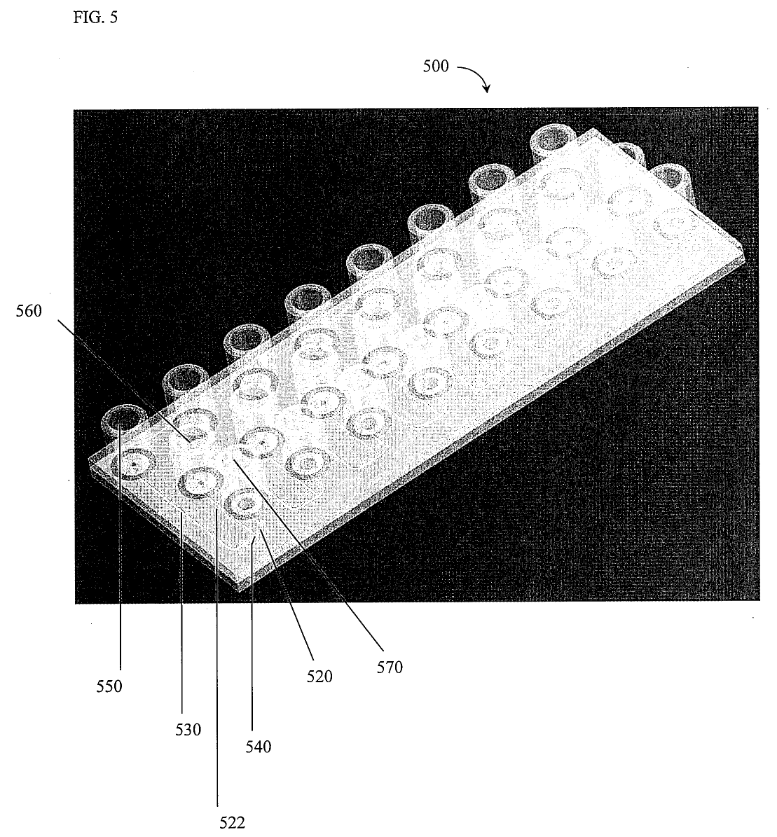

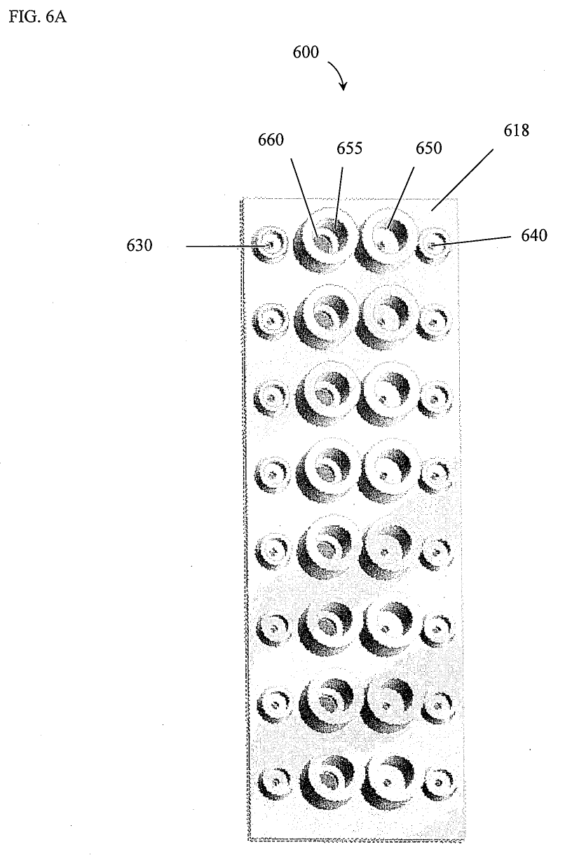

Referring to FIG. 5, the microfluidic chip 500 for sample collection during electrokinetic transport may generally comprise a plurality of modules each having a first pathway comprising a pair of channels 520, 522 intersecting a third channel 530 to form a junction 540; a receptacle in fluid communication with the first channel 520 to receive therein a sample comprising at least one analyte; a pair of electrodes (not shown) associated with the first 570 and second 560 reservoir, respectively, to create an electrophoretic field along the first fluid pathway effective to electrokinetically transport the at least one analyte when a conductive medium is present in the channels 520, 522 and a voltage is applied to the electrodes, wherein the third channel 530 is substantially field-free of the applied electric field; and a third reservoir 550 and a second reservoir 560 in fluid communication with the first channel 520 to create a pressure gradient between the first 520 and third 530 channels and between the second 522 and third 530 channels effective to transport the at least one analyte from the first channel 520 into the second channel 530 when fluid is present in at least one of the reservoirs 550, 560 and the electrophoretic field is substantially simultaneously applied along the first fluid pathway. In at least one embodiment, each second channel 530 may be substantially field-free of the electrophoretic field. In at least one embodiment, channels 520, 522, the 570 and second 560 reservoirs may comprise the first fluid pathway. In at least one embodiment, each module may further comprise a third reservoir 550 in fluid communication with the second channel 530. In at least one embodiment, the second channel 530 and third reservoir 550 may comprise a second fluid pathway. In at least one embodiment, the microfluidic chip may further comprise a power supply (not shown) in communication with each first channel 520 and each second channel 522, wherein the power supply may apply a voltage to the electrodes (not shown) to create an electrophoretic field along the first fluid pathway when a conductive medium is present is the first fluid pathway. In at least one embodiment, the microfluidic chip 500 may further comprise a manifold (not shown) having first and second electrodes, a first reservoir cover and an second reservoir cover for enclosing the first and second ports, respectively, and associating the electrodes in fluid communication with the first fluid pathway and/or the first 560 and second 570 reservoirs such that the electrodes are carried by the manifold. In at least one embodiment, the microstructures of the microfluidic chip 500 may be engineered in a similar manner to the microfluidic devices described above, such as, for example, but not limited to, devices 10, 100, 101, and 200. In at least one embodiment, the microfluidic chip 500 may work in a similar manner to the microfluidic devices described above, such as, for example, but not limited to, devices 10, 100, 101, and 200. In at least one embodiment, a plurality of microfluidic chips may be integrated into a conventional capillary system.

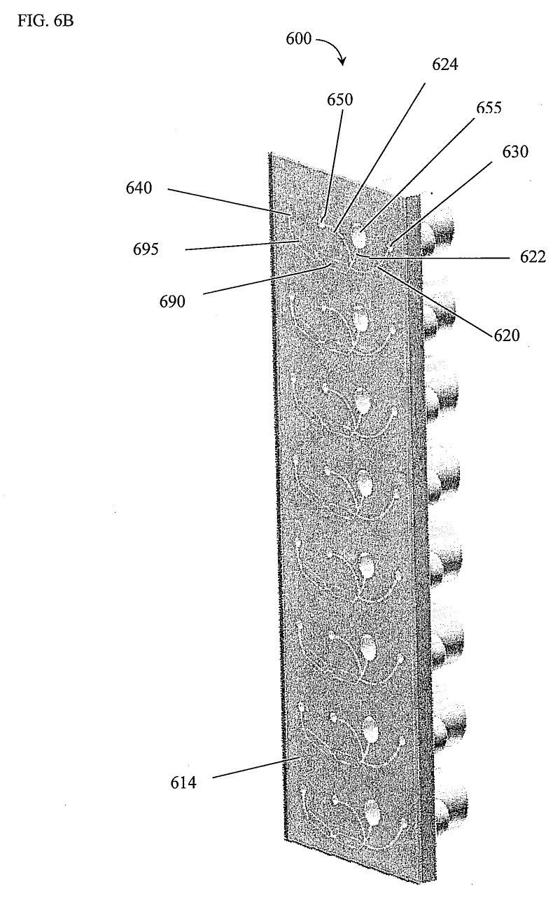

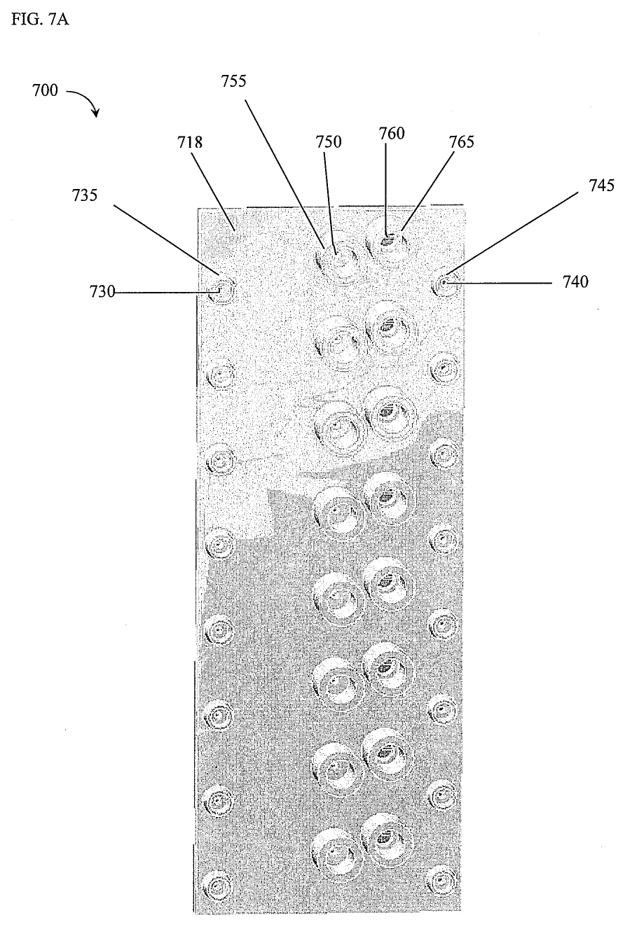

Referring to FIGS. 6A and 6B, in certain exemplary, non-limiting embodiments, the microfluidic device for sample collection during electrokinetic transport may generally further comprise a microfluidic chip 600 formed from a base substrate 614 and a cover substrate 618. In at least one embodiment, the microfluidic chip 600 may generally comprise a first fluid pathway comprising channels 622 and 624, a channel 620 having an inlet 630, an outlet 640, a receptacle 660, a first port 655 and a second port 650, and optionally, a microchamber 690 and/or a sorbent material 695. In at least one embodiment, the microfluidic chip 600 may further comprise a plurality of first fluid pathways, separate channels 620 each having an inlet 630, an outlet 640, a receptacle 660, a first port 655 and a second port 650, and optionally, a microchamber 690 and/or a sorbent material 695, for simultaneously performing electrokinetic transport on a plurality of separate samples each comprising the at least one analyte. In at least one embodiment, the microfluidic chip 600 may further comprise a manifold (not shown) having first and second electrodes, a first reservoir cover and an second reservoir cover for enclosing the first and second ports, respectively, and associating the electrodes (not shown) with a first port 655 and a second port 650 in fluid communication with the first fluid pathway comprising channels 622 and 624 such that the electrodes are carried by the manifold. In at least one embodiment, the microstructures of the microfluidic chip 600 may be engineered in a similar manner to the microfluidic devices described above, such as, for example, but not limited to, devices 10, 100, 101, and 200. In at least one embodiment, the microfluidic chip 600 may work in a similar manner to the microfluidic devices described above, such as, for example, but not limited to, devices 10, 100, 101, and 200,

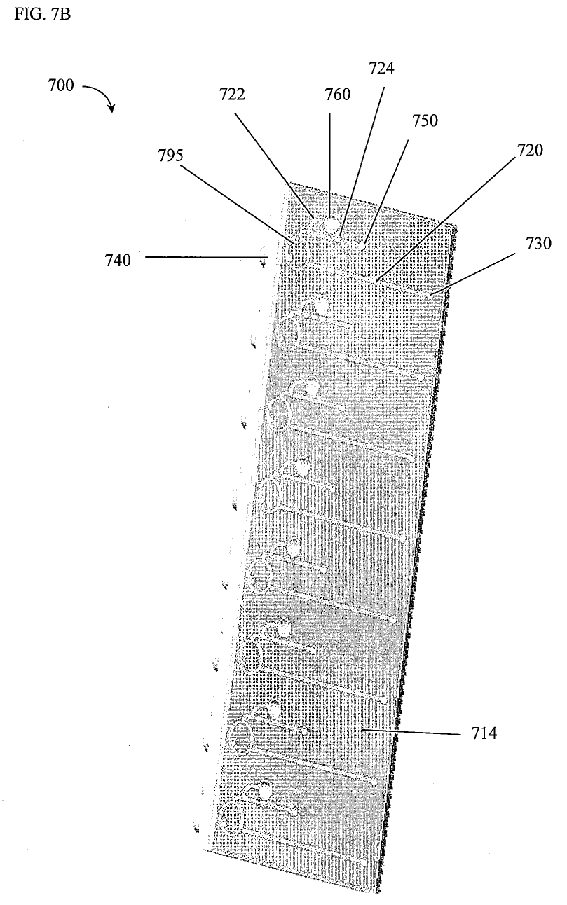

Referring to FIGS. 7A and 7B, in certain exemplary, non-limiting embodiments, the microfluidic device may further comprise a microfluidic chip 700 formed from a base substrate 714 and a cover substrate 718. In at least one embodiment, the microfluidic chip 700 may generally comprise a first fluidic pathway comprising channels 722 and 724, a channel 720 having an inlet 730, an outlet 740, a receptacle 760, a first port 760 and a second port 750, a first reservoir 755, a second reservoir 765, and optionally, a microchamber 795 that in at least some embodiments may contain a sorbent material. In at least one embodiment, the microfluidic chip 700 may further comprise a plurality of first fluidic pathways comprising channels 722 and 724, separate channels 720 each having an inlet 730, an outlet 740, a receptacle 760, first ports 760 and second ports 750, first reservoirs 755, second reservoirs 765, and optionally, a microchamber 795 that in at least some embodiments may contain a sorbent material, for simultaneously performing electrokinetic transport on a plurality of separate samples each comprising at least one analyte. In at least one embodiment, the microfluidic chip 700 may further comprise a manifold (not shown) having first and second electrodes, a first reservoir cover and a second reservoir cover for enclosing the first and second ports, respectively, and associating the electrodes in fluid communication with the first fluidic pathway comprising channels 722 and 724 such that the electrodes are carried by the manifold. In at least one embodiment, the microstructures of the microfluidic chip 700 may be engineered in a similar manner to the microfluidic devices described above, such as, for example, but not limited to, devices 10, 100, 101, and 200. In at least one embodiment, the microfluidic chip 700 may work in a similar manner to the microfluidic devices described above, such as, for example, but not limited to, devices 10, 100, 101, and 200,

### D. Methods for Microfluidic Device

Referring to FIG. 1, in certain exemplary, non-limiting embodiments, a method of sample collection during electrokinetic transport may generally comprise the steps of providing a microfluidic device 10 for electrokinetic transport of at least one analyte having a first channel 20 intersecting a second channel 30 to form a junction 40; introducing a sample comprising the at least one analyte to the first channel 20; applying an electrophoretic field along the first channel 20 effective to transport the at least one analyte into the junction 40, wherein the second channel 30 is substantially field-free from the electrophoretic field; substantially simultaneously applying a pressure gradient across the junction 40 to move the at least one analyte from the junction 40 into the second channel 30; and collecting the analyte in the second channel 30. In at least one embodiment, the electrokinetic transport is capillary electrophoresis. In at least one embodiment, the pressure gradient may be a pressure drop from the first channel 20 to the second channel 30. In at least one embodiment, the pressure gradient may be a pressure drop from the junction 40 to the second channel 30.

In certain exemplary, non-limiting embodiments, a method of sample collection during electrokinetic transport may generally further comprise the step of applying a voltage to a pair of electrodes (not shown) each associated with opposing ends of the first channel 20 to create the electrophoretic field along the first channel 20. In at least one embodiment, the method of sample collection during electrokinetic transport may generally further comprise the step of electrophoretically separating at least one analyte having a lower electrophoretic mobility than a second analyte along the first channel 20 and substantially simultaneously collecting the second analyte in the second channel 30. In at least one embodiment, the at least one analyte at the junction may have a pressure-driven velocity greater than an electrophoretic velocity to move the at least one analyte into the second channel 30.

In certain exemplary, non-limiting embodiments, a method of sample collection during electrokinetic transport may generally further comprise the step of introducing a volume fluid to at least one of a first reservoir 50 and/or a second reservoir 60 each in fluid communication with the first channel 20 to create the pressure drop from the first channel 20 into the second channel 30. In at least one embodiment, the pressure gradient may be a pressure drop from the first channel 20 to the second channel 30. In at least one embodiment, the pressure gradient may be a pressure drop from the junction 40 to the second channel 30. In at least one embodiment, the pressure gradient may encourage electrokinetically transported analytes to move from the first channel 20 into the second channel 30. In at least one embodiment, the pressure drop may transfer at least one analyte in the junction 40 to the second channel 30. In at least one embodiment, the pressure gradient may be hydrostatic pressure proportional to the height of fluid present in the first 50 and/or second 60 reservoirs. In at least one embodiment, the pressure gradient may be a pressure drop from the first channel 20 to the second channel 30 proportional to the height of fluid present in the first 50 and/or second 60 reservoirs. In at least one embodiment, the pressure gradient may be a pressure drop from the junction 40 to the second channel 30 proportional to the height of fluid present in the first 50 and/or second 60 reservoirs. In at least one embodiment, the combined volume of fluid in the first 50 and second 60 reservoirs may be greater than a volume of the fluid in a third reservoir 70 in fluid communication with the second channel 30. In at least one embodiment, the combined volume of the first 60 and second 60 reservoirs may be about 400 μL. In at least one embodiment, the first 50 and second 60 reservoirs each have a volume of fluid of about 200 μL.

In certain exemplary, non-limiting embodiments, a method of sample collection during electrokinetic transport may generally further comprise the step of detecting one or more detectable characteristics of the at least one analyte along at least one of the first 20 and second 30 channels. In at least one embodiment, the at least one analyte may be detecting using a UV-Vis or fluorescence detector as it transits the first 20 or second 30 channel.

In certain exemplary, non-limiting embodiments, a method of sample collection during electrokinetic transport may generally further comprise the step collecting the analyte further comprises the step of collecting the analyte on a sorbent material in the second channel. In at least one embodiment, the method of sample collection during electrokinetic transport may generally further comprise the step removing the analyte collected on the sorbent material.

Referring to FIG. 2, certain exemplary, non-limiting embodiments of a method for sample collection during electrokinetic transport may generally comprise the steps of providing a microfluidic device 100 comprising a first fluid pathway H in fluid communication with a second fluid pathway J, introducing a sample comprising at least one analyte to the first fluid pathway H, e.g., positioning, injecting, introducing, etc. a sample containing the analyte in the receptacle, providing an running buffer into the first H and second J fluid pathways, creating an electrophoretic field in the first fluid pathway H, electrokinetically transporting the analyte from the sample by the applied electric field, and causing the analyte to flow from the first fluid pathway H toward the second fluid pathway J by using a flow restricting feature and/or a flow enhancing feature that encourages the species of interest to flow from the first fluid pathway H toward the second fluid pathway J. In at least one embodiment, the electrophoretic field may be created by positioning the sample intermediate a pair of electrodes (not shown) associated with the first fluid pathway. In at least one embodiment, the analytes may be caused to flow into the second fluid pathway J by using a flow restricting feature at a junction G of the first H and second J fluid pathways, e.g., branch channel 122, and/or a flow enhancing feature in the second fluid pathway J, e.g., microchamber 190. In at least one embodiment, the flow restricting features and flow enhancing features may be fluid flow, osmotic, gravitational, hydrodynamic, pressure gradient, or capillary action.

In certain exemplary, non-limiting embodiments, a method for sample collection during electrokinetic transport may generally further comprise the steps of collecting the separated analyte on a sorbent material 195, e.g., a monolith, packed bed, etc., in the second fluid pathway J, e.g., microchamber 195. The analyte collected on the sorbent material 195 may be further processed, e.g., rinsing, desalting, purifying, chemically reacting, and/or concentrating. The collected analyte may be removed from the sorbent material 195, e.g., flowing an elution liquid into the channel 120 via port 130 to elute the collected analyte from the sorbent material 195. The method of removing the collected analyte from the sorbent material 195 may be optimized, e.g., providing fluid undulation to create vertical assistance mixing. In at least one embodiment, the channel 120 may be formed from a conductive or surface charge bearing material, e.g., glass, and the method may further comprise coating the first and second fluid pathways with a surface charge neutralizing coating to reduce bulk electroosmotic flow.

Referring to FIGS. 4A-4B, in certain exemplary, non-limiting embodiments, a method for sample collection during electrokinetic transport may generally comprise the steps of providing a first fluid pathway P in fluid communication with a second fluid pathway Q, associating a sample (not shown) having at least one analyte with the first fluid pathway P, providing a running buffer into the first P and second fluid pathways Q, creating a pressure drop from the first fluid pathway P towards the second fluid pathway Q, creating an applied electric field in the first fluid pathway P, electrophoretically migrating the at least one analyte from the sample by the applied electric field, and wherein the pressure drop causes the species to flow from the first fluid pathway P toward second fluid pathway Q. In at least one embodiment, the method may further comprise the step of collecting the analyte on a sorbent material (not shown) in the second fluid pathway Q. After collecting the analyte on the sorbent material, the analyte may be further processed, e.g., rinsing, desalting, purifying, chemically reacting, and/or concentrating, and removed from the sorbent material, e.g., flowing an elution liquid through the second fluid pathway Q. The removal of the analyte from the sorbent material may be optimized, e.g., providing fluid undulation to create vertical assistance mixing.

According to certain exemplary, non-limiting embodiments, the method of sample collection during electrokinetic transport in which the sample collection is decoupled from the electrophoretic field may be generally used as follows. In at least one embodiment, the sample may comprise at least one analyte selected from the group consisting of anionic species, cationic species, and any combination thereof. In at least one embodiment, the sample may comprise at least one analyte selected from the group consisting of amino acids, peptides, proteins, nucleic acids, antigens, antibodies, and other biomolecules and biopolymers and any combination thereof. In at least one embodiment, the sample may comprise a gel plug having at least one analyte.

In certain embodiments, samples may be injected into the microfluidic device. In at least one embodiment, samples may be injected into the first reservoir. In at least one embodiment, samples may be injected into a receptacle. Samples may be injected by either hydrodynamic (or hydrostatic) or electrokinetic (electromigration) injection. Hydrodynamic injection may be done by either pressure or siphoning. Siphon injection, also called gravity injection, may be done by raising the sample container and allowing the sample to siphon into the capillary. Pressure injection may be done by either pressuring the sample vial or by applying a vacuum to the exit reservoir. In electrokinetic injection, an electric field may be applied between the sample vial and the exit reservoir to cause the sample to migrate into the capillary. In at least one embodiment, the sample may also be injected with a syringe via a septum in an injection block and/or sample loop.

In certain embodiments, samples may be introduced into the microfluidic device. In at least one embodiment, samples may be introduced into first reservoir. In at least one embodiment, samples may be introduced into a receptacle. In at least one embodiment, a gel band containing the sample may be introduced into the first reservoir. In at least one embodiment, a first end of a bridging fluidic connector (not shown) may be connected to the microfluidic device and a second end of the bridging fluidic connector (not shown) may be connected to a sample container to introduce the sample into the microfluidic device.

In certain embodiments, the sample may be separated using an acrylamide gel, e.g., polyacrylamide and/or agarose matrices, before being introduced into the microfluidic device. After the sample is separated using an acrylamide gel, the sample may be visualized using a non-fixing stain, e.g., modified Coomassie or SYPRO orange. Fixing stains may also be used, but recovery is less efficient because the sample may precipitate from the gel matrix. The gel band containing the sample may be excised from the gel matrix using a scalpel or tubular spot picker. In at least one embodiment, a gel band containing the sample may be introduced into the microfluidic device. In at least one embodiment, a gel band containing the sample may be introduced into the first reservoir. In at least one embodiment, a gel band containing the sample may be introduced into the receptacle. In at least one embodiment, the sample may be electroeluted from the gel band into the first channel.

In certain embodiments, the microfluidic device may be primed with a conductive medium, e.g., an elution liquid, a buffer solution, and the like, at a low flow rate. A syringe, peristaltic pump, or other solvent delivery system (not shown) may be connected to the inlet by a first bridging fluidic connector (not shown). The first and second reservoirs and receptacle may be filled with the elution liquid via a pipette. The elution liquid may fill the channels via capillary action. The manifold (not shown) may be closed after introducing or injecting the sample and priming the device. A collection system (not shown), such as a waste vial rack or a sample collection vial rack, may be connected to the outlet by a second bridging fluidic connector (not shown). By closing the manifold (not shown), the electrodes may be secured in the elution liquid in the reservoirs and fluidically sealed against air introduction. A safety lid (not shown) may be closed over the microfluidic device and the waste vial rack lid (not shown).

In certain embodiments, a pressure gradient may be created by priming the microfluidic device with a conductive fluid, e.g., an elution liquid, a buffer solution, etc. The presence of fluid in the first and/or second reservoirs creates a hydrostatic pressure proportional to the height of fluid in the reservoirs. In at least one embodiment, the pressure gradient may encourage analytes to move from the first channel into the second channel. In at least one embodiment, the pressure gradient may be a pressure drop from the first channel to the second channel. In at least one embodiment, the pressure drop may be created by using a column of fluid in fluid communication with the first channel having a height greater than a column of fluid, if any, above the second channel. In at least one embodiment, the pressure drop may be created by introducing a volume fluid to the first and/or second reservoirs. In at least one embodiment, a pressure drop may be created by filling the first and/or second reservoirs with a volume of fluid greater than the volume of fluid in the third reservoir.

In certain embodiments, a constant voltage of 100-2500V may be applied to the microfluidic device, typically for less than one hour, to create an electric field along the first channel. In at least one embodiment, a voltage of 250 to 500 V may be applied from about 5 minutes to about 30 minutes to the microfluidic device. In at least one embodiment, the electric field may be applied across the first reservoir. In at least one embodiment, the electric field may be applied across the receptacle. In at least one embodiment, the applied electric field may be substantially confined within the first channel such that the second channel is substantially field-free. In at least one embodiment, the second channel may be decoupled from the electrophoretic field. In at least one embodiment, current leakage from the electrophoretic field along the first channel may be applied to the second channel. In at least one embodiment, the second channel may have a third electrode to create an electric field along the second channel. In at least one embodiment, an electric field may be applied along the second channel to assist analytes in the junction to move into the second channel. In at least one embodiment, the second channel may have an electric field that does not discourage analytes in the junction from moving into the second channel.

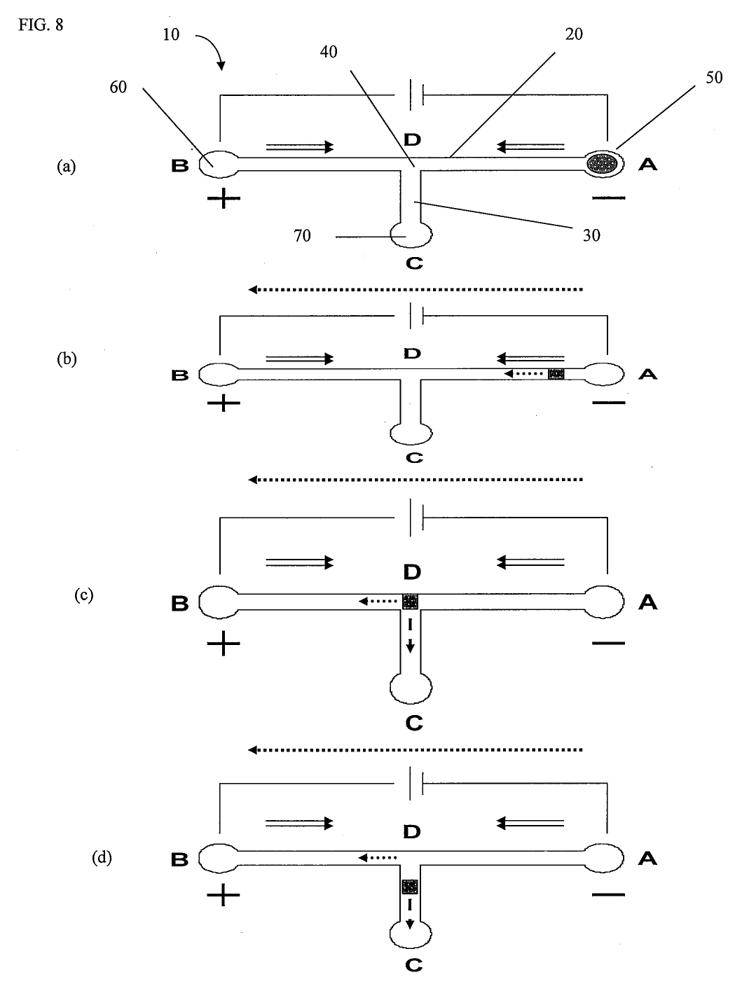

Referring to FIG. 8, in certain embodiments, the electric field along the first channel may induce electrokinetic transport of at least one analyte in the direction from the first electrode (cathode) to the second electrode (anode). In at least one embodiment, the electrokinetic transport is capillary electrophoresis. Referring to FIG. 8(a), in at least one embodiment, a sample containing at least one analyte may be introduced into the microfluidic device 10. Referring to FIG. 8(b), in at least one embodiment, a sample containing the at least one analyte may be electrophoretically separated along the first channel 20. Referring to FIG. 8(c), in at least one embodiment, the at least one analyte at the junction may have a pressure-driven velocity greater than an electrophoretic velocity to move the at least one analyte from the junction into the second channel. In at least one embodiment, a sample comprising at least one analyte having a lower electrophoretic mobility than a second analyte may be electrophoretically separated along the first channel while substantially simultaneously collecting the second analyte in the second channel. In at least one embodiment, a sample containing a first analyte may be electrophoretically separated along the first channel while a second analyte may be collected along the second channel. In at least one embodiment, the analyte in the second channel may have a pressure-driven velocity that is less than its electrophoretic velocity. Referring to FIG. 8(d), in at least one embodiment, the at least one analyte may be collected in the second channel 30.

The principles of electrokinetic transport may govern the movement of the charged analytes in the first channel. As previously described, the pressure drop at the junction may encourage the separated analytes to migrate towards the second channel instead of the second electrode. The flow restricting and/or flow enhancing features may encourage the separated analytes to migrate towards the outlet in fluid communication with the second channel instead of the second electrode. The sample may be detected with a UV-Vis or fluorescence detector as it transits the first channel or the second channel. The sample may be collected without turning off the electrophoretic field along the first channel and subjected to subsequent analysis for identification and characterization. The sample may be collected with a membrane or a porous matrix in the second channel.

In certain embodiments, the separated analytes may be collected with a sorbent material, e.g., a monolith or packed bed, positioned in the second channel. In general, after the voltage is turned off, the analytes collected on the sorbent material may be removed or eluted from the sorbent material and/or subjected to further processing. The waste vial rack (not shown) can be removed and replaced with a sample collection vial rack (not shown). A second elution liquid can be introduced at the inlet to elute the analytes collected on the sorbent material into the sample collection vial. Finally, the sample vials can be removed and the proteins can be subjected to subsequent identification and analysis.

The movement of the charged analytes in the microfluidic device may be based on the analytes' electrophoretic mobilities and the principles of electrokinetic transport. The electrophoretic movement of the separated analytes from the along the first channel towards the junction may be influenced by the electrokinetic attraction of the separated analytes to the second electrode. Without intending to be bound by any particular theory, the behavior exhibited by the separated analytes may be described as the sum of the forces experienced by the analytes along the first channel, as shown in Equations 1 and 2,

F_{Total}=F₁+F₂+F₃ . . . etc. (1)

Here,

F_{Total}=F_{E}+F_{HD}+F_{HS} (2)

where, F_{E}≡electrokinetic force, which is a sum of the forces on the analytes due to its inherent electrophoretic mobility and the forces of bulk electroosmotic flow within the channel, F_{HD}≡hydrodynamic force, and F_{HS}≡hydrostatic force.

In certain embodiments, the substrate may be designed such that by chemical treatment or natural properties it has a near-neutral or neutral surface charge, thereby eliminating bulk electroosmotic flow (EOF). If a negative surface charge is present on the substrate, then a bulk EOF flow will be established toward the first electrode (cathode); conversely, if a positive surface charge is present on the substrate, then a bulk EOF flow will be established toward the second electrode (anode). Since EOF is near zero in the fluidic channel network, F_{E} is then approximated by the electrophoretic force on the proteins as produced by their inherent electrophoretic mobilities in the applied electric field. Therefore, in the case of electrically conductive, semi-conductive, or surface charge bearing substrates, the microstructures should be chemically treated with an insulating layer to mask the surface charges.

The hydrodynamic force may be due to back pressure from the channel size restrictions and the solvent delivery system at the inlet. The hydrostatic force is due to the relatively large volumes and column heights of fluid provided in the first and/or second reservoirs as compared to the volume and column height of the third reservoir. Prior to the junction, F_{E} dominates Equation 2 such that F_{Total}≈F_{E}. The microfluidic structures on the device, in particular, the channels, reservoirs, and any flow restricting and/or flow enhancing features, may be designed such that the hydrodynamic force balances the hydrostatic force, i.e., the vector sum of F_{HS} and F_{HD} is approximately zero. However, at the junction, the analytes may experience the new unbalanced forces F_{HS} and F_{HD} deriving from both directions of the second reservoir and first reservoir such that F_{HD}+F_{HS}>>F_{E}. Referring to FIG. 8(d), in at least one embodiment, the hydrodynamic and/or hydrostatic forces encourage the analytes at the junction to move into the second channel.

The movement of the separated analytes in the microfluidic device may be governed by similar principles of electrokinetic transport as described above. In addition to these general principles, a pressure drop from the first channel towards the second channel may cause the analytes to flow from the first channel into the second channel. The hydrodynamic force from the pressure drop should be larger than the electrokinetic force to cause the analytes to flow from the electrophoretic field towards the second channel. The magnitude of the pressure drop between various sections of the microchannel can be determined by calculating the hydrostatic pressure along each section of microchannel. The hydrostatic pressure along the channel can be described by Equation 3

P=ρ·g·h+Pₐ (3)

where, P≡hydrostatic pressure, ρ≡liquid density, g≡gravitational acceleration, h≡height of liquid relative to the fluid within channel, and Pₐ≡atmospheric pressure.

The dynamics of fluid movement in microfluidic device are generally governed by the diameter and length of the microchannel structure according to Poiseuille's Law. The magnitude of the pressure drop along each section of the first channel can be estimated using Poiseuille's Law given in Equation 4

$$Q = \frac{Δ P \cdot Π \cdot {r}^{4}}{8 \cdot η \cdot L} \qquad ( 4 )$$

where, Q≡volumetric flow rate, ΔP≡pressure drop, Π≡pi, r≡radius of channel, η≡viscosity, L≡length of channel. Poiseuille's equation is only strictly valid for circular flow channels. The channels of this invention can have cross-sections of various shapes, e.g., circular, wedge-shaped and/or substantially rectangular. Thus, in embodiments with non-circular cross-sections, Poiseuille's equation can be considered only as an approximate relation between the variables represented. According to Poiseuille's equation, the pressure drop is directly proportional to the length of the microchannel structure and the radius or diameter of the microchannel structure has a fourth power effect on the pressure drop.

The dimensions and values disclosed herein are not to be understood as being strictly limited to the exact numerical values recited. Instead, unless otherwise specified, each such dimension is intended to mean both the recited value and a functionally equivalent range surrounding that value. For example, a dimension disclosed as “40 mm” is intended to mean “about 40 mm”.

All documents cited in the Detailed Description of the Invention are, in relevant part, incorporated herein by reference; the citation of any document is not to be construed as an admission that it is prior art with respect to the present invention. To the extent that any meaning or definition of a term in this document conflicts with any meaning or definition of the same term in a document incorporated by reference, the meaning or definition assigned to that term in this document shall govern.

While particular embodiments of the present invention have been illustrated and described, it would be obvious to those skilled in the art that various other changes and modifications can be made without departing from the spirit and scope of the invention. It is therefore intended to cover in the appended claims all such changes and modifications that are within the scope of this invention.

What is claimed is:

1. A microfluidic device for collecting a sample during electrokinetic transport, the device comprising:
(a) a first channel intersecting a second channel to form a junction;
(b) a receptacle in fluid communication with the first channel to receive therein a sample comprising at least one analyte;
(c) a pair of electrodes associated with the first channel to create an electrophoretic field along the first channel effective to electrokinetically transport the at least one analyte when a conductive medium and the electrodes are present in the first channel and a voltage is applied to the electrodes, wherein the second channel is substantially field-free of the electrophoretic field; and
(d) a first reservoir and a second reservoir in fluid communication with the first channel to create a pressure gradient between the first and second channels effective to transport the at least one analyte from the first channel to the second channel when fluid is present in at least one of the reservoirs and the electrophoretic field is substantially simultaneously applied along the first channel.

2. The device of claim 1, wherein the electrokinetic transport is capillary electrophoresis.

3. The device of claim 1, wherein the at least one analyte is selected from the group consisting of anionic species and cationic species.

4. The device of claim 1, wherein the pressure gradient is a pressure drop from the first channel to the second channel.

5. The device of claim 4, further comprising a third reservoir in fluid communication with the second channel wherein the first and second reservoirs have a combined volume of fluid greater than a volume of fluid of the third reservoir to create the pressure drop.

6. The device of claim 1, wherein the first reservoir comprises the receptacle.

7. The device of claim 1, further comprising a power supply for applying the voltage to the pair of electrodes.

8. The device of claim 1, wherein one of the pair of electrodes is associated with the first reservoir and the other electrode is associated with the second reservoir.

9. The device of claim 8, further comprising a manifold to seal the reservoirs and associate the electrodes in fluid communication with the reservoirs.

10. The device of claim 1, wherein the first and second channels each have widths and depths in the range of from about 1 μm to about 500 μm.

11. The device of claim 1, wherein the first and second channels each have lengths in the range of from about 3 mm to about 50 mm.

12. The device of claim 1, wherein the channels are each independently formed from one of electrically non-conductive substrates, electrically conductive substrates having a substantially surface charge-neutralizing coating, or surface charge bearing substrates having a substantially surface charge-neutralizing coating.

13. The device of claim 1, further comprising a sorbent material in the second channel.

14. The device of claim 13, wherein the sorbent material is selected from the group consisting of a monolith and a packed bed.

15. The device of claim 14, wherein the monolith is selected from the group consisting of a porous polymer monolith, a porous silica monolith, porous hybrid polymer-silica monolith, a functionalized porous polymer monolith, a functionalized porous silica monolith, and a functionalized porous hybrid polymer-silica monolith.

16. The device of claim 15, wherein the monolith is formed integrally in the second channel.

17. The device of claim 1, further comprising a microfluidic chip.

18. The device of claim 17, further comprising a plurality of the channels each having the receptacle, pair of electrodes, and reservoirs to separately perform sample collection during electrokinetic transport.

19. The device of claim 18, wherein each of the plurality of the channels further comprises a third reservoir in fluid communication with the second channel wherein the first and second reservoirs have a combined volume of fluid greater than a volume of fluid of the third reservoir to create the pressure gradient.

20. The device of claim 18, wherein each of the plurality of the channels further comprises a sorbent material in each second channel.

21. A method of sample collection during electrokinetic transport, the method comprising the steps of:
(a) providing a microfluidic device for electrokinetic transport of at least one analyte having a first channel intersecting a second channel to form a junction;
(b) introducing a sample comprising the at least one analyte to the first channel;
(c) applying an electrophoretic field along the first channel effective to transport the at least one analyte into the junction, wherein the second channel is substantially field-free from the electrophoretic field;
(d) substantially simultaneously applying a pressure gradient across the junction to move the at least one analyte from the junction into the second channel; and
(e) collecting the at least one analyte in the second channel.

22. The microfluidic device of claim 21, wherein said electrokinetic transport is capillary electrophoresis.

23. The method of claim 21, further comprising the step of applying power to a pair of electrodes each associated with opposing ends of the first channel to create the electrophoretic field along the first channel.

24. The method of claim 21, further comprising the step of electrophorectically separating at least one analyte having a lower electrophoretic mobility than a second analyte along the first channel and substantially simultaneously collecting the second analyte in the second channel.

25. The method of claim 21, wherein the at least one analyte at the junction has a pressure-driven velocity greater than an electrophoretic velocity to move the at least one analyte into the second channel.

26. The method of claim 21, wherein the pressure gradient is a pressure drop from the first channel to the second channel.

27. The method of claim 26, further comprising the step of introducing a volume fluid to at least one of a first reservoir and a second reservoir each in fluid communication with the first channel to create the pressure drop.

28. The method of claim 27, wherein the combined volume of fluid in the first and second reservoirs is greater than a volume of fluid in a third reservoir in fluid communication with the second channel.

29. The method of claim 28, wherein the combined volume comprises 200 μL in the first reservoir and 200 μL in the second reservoir.

30. The method of claim 21, wherein the at least one analyte is selected from the group consisting of anionic species and cationic species.

31. The method of claim 21, further comprising the step of detecting one or more detectable characteristics of at least one analyte along at least one of the first and second channels.

32. The method of claim 21, wherein the step of collecting the analyte further comprises the step of collecting the analyte on a sorbent material in the second channel.

33. The method of claim 32, further comprising the step of removing the analyte collected on the sorbent material.
